(19) United States
(12) Patent Application Publication
(10) Pub. No.: US 2003/0070404 A1
(43) Pub. Date: Apr. 17, 2003

(54) Glove box contamination-proof mail handling

(76) Inventor: Gerry Calabrese, Fort Lauderdale, FL (US)

Correspondence Address: LERNER AND GREENBERG, P.A., POST OFFICE BOX 2480, HOLLYWOOD, FL, 33022-2480, US

(21) Appl. No.: 10/271,282

(22) Filed: Oct. 15, 2002

Related U.S. Application Data
(60) Provisional application No. 60/328,938, filed on Oct. 12, 2001.

(51) Int. Cl. B01D 50/00

(52) U.S. Cl. 55/385.2; 454/187

(57) ABSTRACT

A glove box assembly is used for contamination-proof mail handling. Items of mail, after they are placed into the glove box cavity and the cavity is sealed, are opened and simultaneously examined for any suspiciously hazardous materials. Harmful exposure to chemicals and biological cultures can be substantially reduced if mail items, such as envelopes and small packages are opened in the mail handling cavity while it is hermetically sealed. The glove box assembly has a see-through lid which allows completely open inspection of all mail items as they are being opened. The cavity may be lighted and any type of mail processing device may be placed at ready inside the cavity.

### CROSS-REFERENCE TO RELATED APPLICATION

This non-provisional application claims the benefit, under 35 U.S.C. §119(e), of copending provisional application No. 60/328,938, filed Oct. 12, 2001.

### BACKGROUND OF THE INVENTION

1. Field of the Invention

The invention relates to a mail handling apparatus and, more specifically, to a glove box with an integrated mail handling apparatus that allows contamination-proof handling of mail items.

2. Description of the Related Art

Glove boxes are well known in chemical laboratory environments and in the context of radioactive material processing. By way of example, U.S. Pat. No. 5,310,517 to Dams et al. discloses a glove box with an insertion glove suited for handling radioactive materials. The glove is made of a multilayer material including a layer of polyurethane, a thermoplastic polyester urethane layer, and a synthethic rubber layer. A glove box with a filter system is disclosed in U.S. Pat. No. 6,235,072 B1 to Kopylov et al.. There, the filter system includes a first filter stage and a second filter stage for filtering out very fine particles.

The anthrax scare during the latter part of 2001 and early 2002, and certain predictions within the rubrik biological and chemical terror attacks, have shown that the mail system and related carrier systems are prime candidates for the spread of hazardous materials and substances. Certain preemptive and prophylactic measures, such as improved screening mechanisms and large-scale irradiation, have reduced the danger to a considerable degree. Also, some mail rooms, specifically in high-risk environments (e.g., prisons, post offices, federal and state offices, etc.) have installed limited safety measures for mail clerks, which includes partial irradiation and protective gear such as gloves and masks. However, there still exists a need to further improve the individual screening ability and to provide for a safer system, if only for psychological reasons.

### SUMMARY OF THE INVENTION

It is accordingly an object of the invention to provide a mail handling system for small-scale mail handling and monitoring which overcomes the above-mentioned disadvantages of the heretofore-known devices and methods of this general type and which provides for a mail handling system that offers considerable safety, yet is very simple and easy to handle, and is very inexpensive.

With the foregoing and other objects in view there is provided, in accordance with the invention, a glove box assembly, comprising:

a glove box body formed with a trough-shaped cavity for receiving therein items of mail;

a closure device disposed to close the trough-shaped cavity of the glove box body and to hermetically seal the cavity towards an outside thereof;

at least one mail handling device disposed to handle items of mail inside the cavity with access from outside the glove box body, such that items of mail can be handled inside the cavity while the cavity remains hermetically sealed; and

a mail processing device disposed inside the cavity and accessible to the mail handling device, such that items of mail may be delivered by the mail handling device for processing by the mail processing device.

In accordance with an added feature of the invention, the mail handling device is a glove attached to the glove box body and accessible through an access opening formed in the glove box body.

In accordance with an additional feature of the invention, the glove box body is formed with two frontal access openings and the mail handling device are two gloves respectively sealed against the frontal access openings and freely movable inside the cavity by respective hands inserted through the access openings.

In accordance with another feature of the invention, the glove box body is formed with a flange rim surrounding an entire opening into the cavity, the closure device is a lid formed with a substantially complementary surface to the flange rim, and wherein a sealing ring extends along the flange rim and the lid and the flange rim sandwich the sealing ring therebetween when the lid is closed.

In accordance with a further feature of the invention, at least a portion of the closure device or the glove box body is formed with a transparent viewing window. Preferably, however, the closure device and/or the glove box body are formed of a transparent material.

In accordance with again an added feature of the invention, there is provided a lighting device inside the cavity.

Similarly to the mail processing device described above, the lighting device may also be battery operated. This ensures that the system remains completely sealed (when the lid is closed) without requiring expensive and/or failure-prone lead-through devices.

In accordance with a concomitant feature of the invention, the closure device is a transparent lid disposed to allow substantially unobstructed viewing access into the cavity while the lid hermetically seals said cavity.

The proper use of the novel glove box assembly can substantially reduce the danger of exposure to airborne substances Harmful exposure to chemicals and biological cultures can be substantially reduced if mail items, such as envelopes and small packages are opened in the mail handling cavity while it is hermetically sealed. Any type of mail opener can be deposited inside the box, including scissors, slicers, cutters, and the like.

Other features which are considered as characteristic for the invention are set forth in the appended claims.

Although the invention is illustrated and described herein as embodied in a glove box with an integrated mail handling apparatus, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a perspective view of a glove box according to the invention, with an open lid;

FIG. 2 is a rear elevational view of the glove box;

FIG. 3 is a partial side-perspective view of the glove box;

FIG. 4 is a vertical section centrally through one of the glove access openings in the front wall of the glove box; and

FIG. 5 is a top perspective view of a lid of the glove box according to the invention;

### DESCRIPTION OF THE PREFERRED EMBODIMENTS

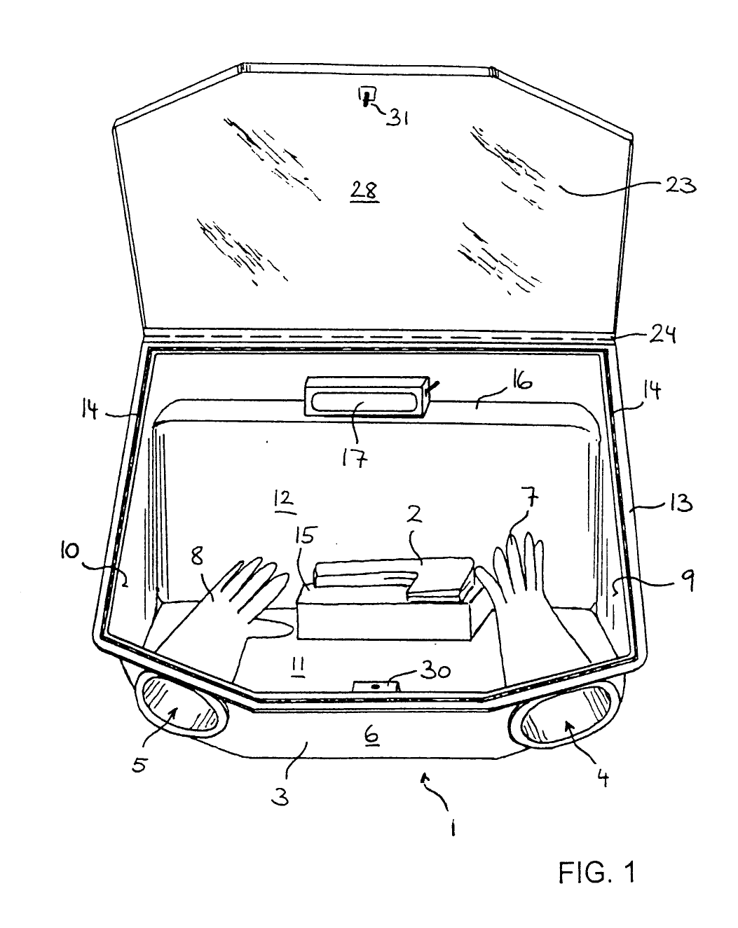

Referring now to the figures of the drawing in detail and first, particularly, to FIG. 1 thereof, there is seen a glove box 1 according to the invention, with an integrated mail processing device 2. The glove box 1 has a main box housing 3 which is basically formed as a square trough box. Two frontal openings 4 and 5 are provided in a front wall 6 for the insertion of a right and left arm, respectively, into a right-hand glove 7 and a left-hand glove 8. The gloves 7 and 8, in a generic sense, may be considered mail handling devices. The front wall 6 is slightly inclined from a vertical towards the user of the glove box 1. Side walls 9 and 10 are aligned substantially vertical when a floor 11 is in its horizontal orientation. A backwall 12 is integrally formed together with the front wall 6, the side walls 9, 10, and the floor 11, in a single mold. Preferably, the box 1 is a hot press-molded or injection-molded trough. All of the walls and various indentations are formed to enable a one-step molding process and easy mold removal. The top of the box is formed with an outwardly pointing flange rim 13 that surrounds the entire opening at the top. The flange rim 13 is substantially flat and it supports a sealing O-ring 14 that encloses the entire opening. The sealing O-ring 14 is preferably a neoprene seal.

The gloves 7 and 8 are chosen with a view to the application, i.e., the type of protection to be afforded. In the preferred embodiment, the gloves 7 and 8 are produced by Ansell Edmont Company, England, and they are commercially sold under the mark Sol-Vex®-product number 37-185, size 10.

The letter opener 2 illustrated herein is to be understood as exemplary only. Any mail opening tool may be utilized inside the trough of the box 1, including knives, scissors, box cutters, slicers, and the like.

The backwall 12 is formed with a first ledge 15 and a second ledge 16. The first ledge 15 supports the mail handling device 2—here a battery-operated letter opener—and the upper ledge 16 supports a lamp 17. Both electrically driven devices 2 and 17 may be battery-operated or they may be provided from an external power source. In the latter situation, the glove box 1 is provided with at least one sealed cable lead-through, via which the electrical wire or wires may be guided into the interior chamber of the box 1. Any further number of envelope openers, box cutters, or the like may be provided inside the box 1.

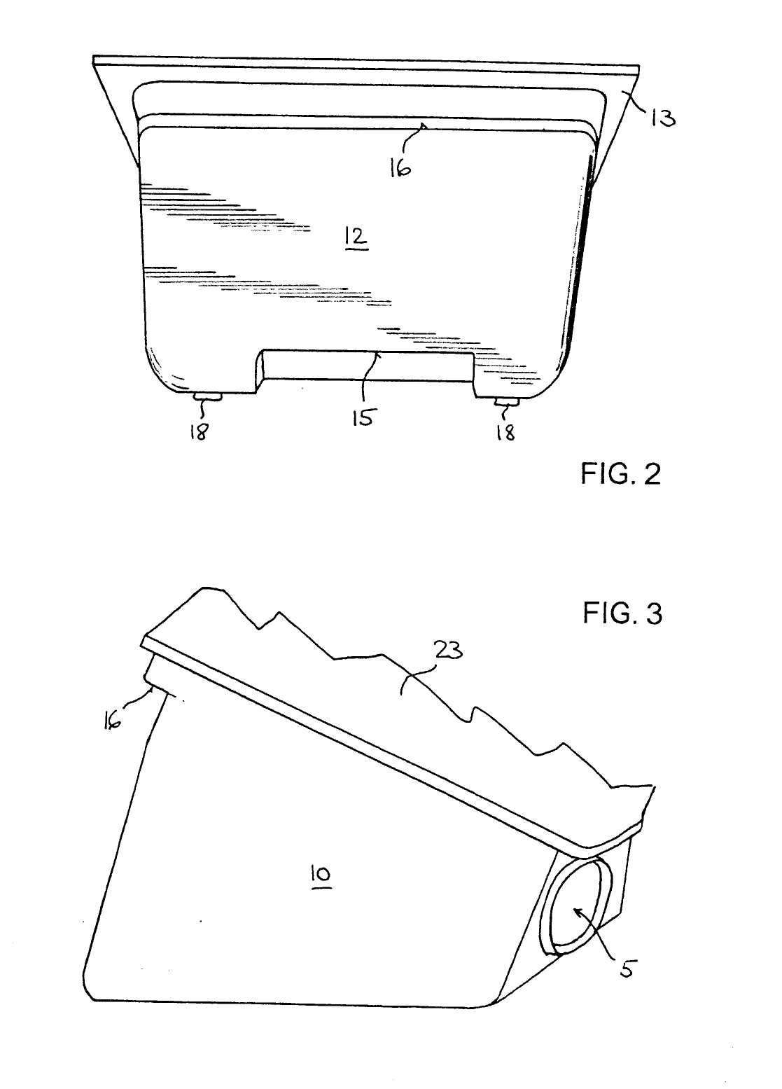

The one-piece integral mold construction of the box 1 becomes evident from the rear elevational view of FIG. 2. There, the first ledge 15 is shown as formed by an impressed indentation. Further, the second ledge 16 is shown to be an outside step in the mold configuration. In addition to providing the useful surfaces and structures inside the box 1, these indentations serve the purpose of stabilizing the box in structural terms. It will be understood by those of skill in the art that any substantial deformation in a mold shape, and specifically compound bends such as double-return shapes, provide a considerable improvement in structural rigidity. As further shown in FIG. 2, the box 1 is supported on four or more silicone or rubber feet 18. The rubber feet 18 stabilize the box on a horizontal support surface against sliding.

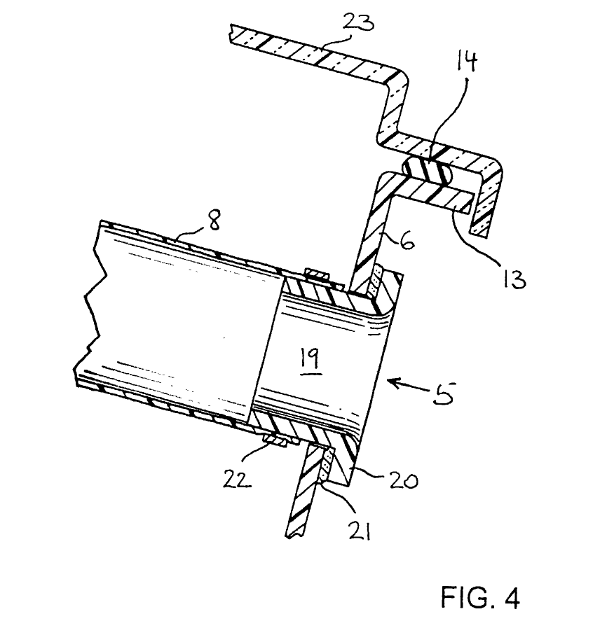

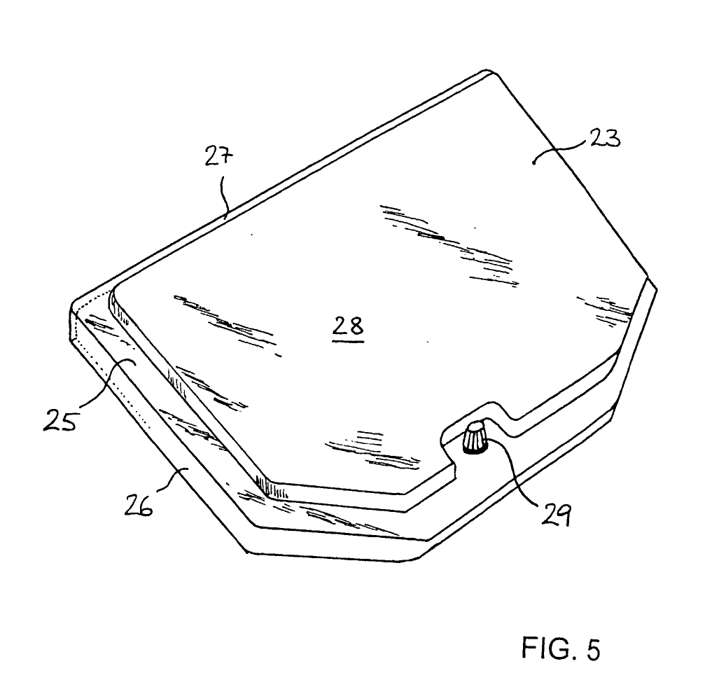

With reference to FIG. 4, which represents a vertical section centrally through the glove opening 5, the opening 5 is lined with a cylindrical stub 19 with a flange 20. The front wall 6 is provided with a round opening into which the stub 19 is inserted. The necessary seal between the box 1 and the stub 19 is ensured by an adhesive 21 between the flange 20 and the wall 6. Preferably, the adhesive 21 is a so-called VHB tape (very-high-bond) available from 3M Company. The glove 8 is attached at the stub 19 with a pressure ring 22. Simple hose clamps have proved very advantageous pressure rings 22, because the render the gloves 8 and 7 easily exchangeable.

The glove box 1 can be sealed by closing a lid 23, when presses against the sealing O-ring 14. The lid 23 is articulated at the top of the backwall 12 about a piano hinge 24 or the like. The hinge 24 may be screwed, clamped, or glued to the lid 23 and to the flange rim 13 of the box 1. Again, VHB tape has proved to be very advantageous in this context, that is, a strip of VHB tape is provided between the hinge 24 and the flange rim 13 and a strip is provided between the hinge 24 and the back edge of the lid 23. The hinge 24 is not required to provide any sealing function, only structural integrity. The sealing function is ensured by lid 23, the flange rim 13, and the sealing ring 14 sandwiched therebetween.

Referring now to FIG. 3, the lid 23 is formed with a substantially flat sealing surface 25 which corresponds in shape to the flange rim 13. When the sealing surface 25 and the flange rim 13 sandwich the sealing O-ring 14 in-between, the glove box 1 is completely sealed. The lid 23 is formed of a plastic material that is transparent, at least in a viewing area in the center. Also, the lid 23 should not be excessively heavy, so as to assure that the device can be easily handled. In order to provide the necessary structural rigidity of the lid 23—the lid must, while the box is sealed, constantly and evenly press against the sealing ring 14—the same is formed with several compound bends. For example, outwardly of the flat sealing surface 25, the lid is formed with a 900 degree bend 26 that extends from one rear corner around the front and to the other rear corner. The back edge 27 of the lid 23 is not provided with the bend 26, so as to allow proper bonding with the hinge 24. Furthermore, the lid 23 is formed with a raised portion 28, which forms the viewing window per se. In a preferred embodiment, the entire lid is molded of a completely transparent material (e.g. polycarbonate). It may also be formed of translucent or opaque material. In that case, however, the lid 23 must be provided with a viewing window in most applications. In one application, the mail may be inspected with a camera which is disposed inside the box. In that case, of course, a viewing window is not be absolutely necessary. Such a camera would preferably be a wireless camera with a battery power pack. As noted above, the electrically driven elements inside the box may also be operated with an external power source. In that case, the box would be provided with a sealed lead-through.

The lid 23 must be closed and latched during use. There is provided, therefore, a locking and latching mechanism which is operated by a knob 29. The latch engages into a lock 30 that is integrated and/or attached inside the box 1. Any type of latching mechanism may be employed. It has proved advantageous to provide a fine-adjusting screw mechanism 31 or an adjustable bayonet closure. These allow the lid 23 to be pulled onto the box 1 with near infinite adjustment, which allows for variations and imperfections in the sealing O-ring 14 to be compensated.

In an alternative embodiment, the glove box 1 may, instead of the table-top embodiment illustrated here, be formed as an integrated wall or door-mounted mail insertion box. In that case, the backwall 12 is provided with an opening that is aligned with a mail slot or the like, into which the mail carrier can drop the mail pieces directly through the mail slot.

It will be understood that the glove box 1 provided here is not a completely integrated safety system. However, it is designed and configured to provide contamination protection during the opening of mail pieces. If, during the opening of an item of mail, anything suspicious is detected, one may consult with the proper authorities and have the suspicious items removed and tested. The novel glove box provides for a simple system that can be easily handled, it is lightweight, and it provides for a sufficient seal in many pertinent applications.

1. A glove box assembly, comprising:
a glove box body formed with a trough-shaped cavity for receiving therein items of mail;
a closure device disposed to close said trough-shaped cavity of said glove box body and to hermetically seal said cavity towards an outside thereof;
at least one mail handling device disposed to handle items of mail inside said cavity with access from outside said glove box body, such that items of mail can be handled inside said cavity while said cavity remains hermetically sealed; and
a mail processing device disposed inside said cavity and accessible to said mail handling device, such that items of mail may be delivered by said mail handling device for processing by said mail processing device.

2. The glove box assembly according to claim 1, wherein said mail handling device is a glove attached to said glove box body and accessible through an access opening formed in said glove box body.

3. The glove box assembly according to claim 1, wherein said glove box body is formed with two frontal access openings and said mail handling device are two gloves respectively sealed against said frontal access openings and freely movable inside said cavity by respective hands inserted through said access openings.

4. The glove box assembly according to claim 1, wherein the glove box body is formed with a flange rim surrounding an entire opening into said cavity, said closure device is a lid formed with a substantially complementary surface to said flange rim, and wherein a sealing ring extends along said flange rim and said lid and said flange rim sandwich said sealing ring therebetween when said lid is closed.

5. The glove box assembly according to claim 1, wherein at least a portion of said closure device or said glove box body is formed with a transparent viewing window.

6. The glove box assembly according to claim 5, wherein one of said closure device and said glove box body is formed of a transparent material.

7. The glove box assembly according to claim 1, which further comprises a lighting device disposed inside said cavity.

8. The glove box assembly according to claim 1, wherein said closure device is a transparent lid disposed to allow substantially unobstructed viewing access into said cavity while said lid hermetically seals said cavity.
